(19) United States
(12) Patent Application Publication
(10) Pub. No.: US 2017/0191848 A1
(43) Pub. Date: Jul. 6, 2017

(54) LOCATION DETECTION AND USER INFORMATION PROCESSING FOR INTELLIGENT SELECTION OF PARKING LOCATIONS

(71) Applicant: PAYPAL, INC., San Jose, CA (US)

(72) Inventor: Ashley Jones, San Jose, CA (US)

(21) Appl. No.: 14/985,240

(22) Filed: Dec. 30, 2015

(51) Int. Cl. G01C 21/36; G01C 21/34

(52) U.S. Cl. CPC G01C 21/3685; G01C 21/3667; G01C 21/3484

(57) ABSTRACT

There are provided systems and methods for location detection and user information processing for intelligent selection of parking locations. A computing device, such as a mobile device or a GPS console device of a vehicle may provide travel information to a service provider, where the travel information is associated with an endpoint the user is travelling to using a vehicle. The service provider may utilize mapping information for the location associated with the endpoint for the user to determine a parking location that the user may utilize for the vehicle at or nearby the endpoint for the user. The service provider may pull a starting or current location for the user using a device of the user, and may determine a travel route to the parking location from the user's starting or current location. The service provider may determine the parking location based on parking preferences for the user.

### TECHNICAL FIELD

The present application generally relates to user data processing for intelligent decision making, and more specifically to location detection and user information processing for intelligent routing to and selection of parking locations.

### BACKGROUND

A user may wish to travel between two endpoints using a vehicle, and may set travel information, such as a starting or current location of the user and a destination endpoint for the user. Modern computing devices, such as mobile smart phones and/or GPS capable console computing devices of the vehicle, may provide location and routing services between such endpoints. Often, when using these mapping devices, the mapping devices may provide a general route to the endpoint, and may not display nearby parking for the user. Thus, the user may spend considerable time finding parking nearby the endpoint where the endpoint does not have parking. This can cause further delay in large cities where streets may be crowded, one way, or have confusing signals and turns. Moreover, parking may be full at or nearby the endpoint, and the user may require guidance to a parking lot with available spaces. Even where the endpoint offers parking and has available parking spots, the parking may be expensive or may not meet other requirements of the user, such as valet, covered parking, and/or security concerns. Thus, the user may not receive optimized parking information when planning a route to an endpoint.

### BRIEF DESCRIPTION OF THE DRAWINGS

FIG. 1 is a block diagram of a networked system suitable for implementing the processes described herein, according to an embodiment;

FIG. 2 is an exemplary environment having travel routes to parking locations determined based on mapping information and a destination endpoint, according to an embodiment;

FIG. 3 is an exemplary system environment showing a communication device of a user receiving a travel route to a parking location determined from mapping information around a destination endpoint for the user, according to an embodiment;

FIG. 4 is a flowchart of an exemplary process for location detection and user information processing for intelligent selection of parking locations, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for location detection and user information processing for intelligent selection of parking locations based on an endpoint destination. Systems suitable for practicing methods of the present disclosure are also provided.

A user may utilize a computing device prior to or while traveling to a location by vehicle. The computing device for the user may correspond to a mobile computing device, such as a mobile smart phone, tablet computer, or other type of mobile device including processes and application for execution by the computing device. In other embodiments, the computing device may correspond to a device associated with the vehicle, such as a console computing device. The computing device may at least including mapping and routing functionality for a travel route between two or more locations, as well as a communication processes to communicate with a service provider server that may provide directions along the travel route between the two or more locations. Additionally, the computing device may include a GPS locator or other location detection service, which may be used to determine a current location for the user.

The user may utilize a travel or mapping application of the computing device to enter in at least a destination endpoint. The destination endpoint may correspond to a physical name of a location, address for the location, or other identifier allowing the mapping application to determine a destination that the user wishes to travel to using the vehicle. The mapping application may include map information allowing the mapping application to look up the destination endpoint and display the destination endpoint on a map to the user. The mapping application may further receive a starting location, as well as any intermediary locations, which the mapping application may display on the map and/or use to determine a travel route between the locations. The travel route may be highlighted or otherwise displayed on the map, including a listing of travel directions. In other embodiments, the mapping application may utilize a service provide to retrieve the map information and/or determine a travel route between two or more locations. In various embodiments, the start location may be detected using the GPS locator or other location detection service of the device of the user. Additionally, the location detection service may also be used to update the displayed map and/or route to the destination endpoint as the user travels, for example, by detecting a current location of the user and updating the map and/or route based on the current location of the user.

The travel information having at least the destination endpoint for the user may also be communicated to a service provider, such as an online service provider offering parking services to a user and/or an online payment provider providing payment services to the user. The service provider may utilize the travel information to determine one or more nearby parking locations for the destination endpoint. The nearby parking location(s) may be one or more parking lots, garages, or other physical locations where users may park and leave their vehicle while visiting the destination endpoint. The online service provider may determine the parking locations based on a distance from the destination endpoint, as well as additional factors as discussed herein. Additionally, the online service provider may choose one or more of the parking locations to direct the user to based on access to the parking location from the destination endpoint. For example, if the user's route takes the user by an entrance to the parking location while traveling to the destination endpoint, the parking location may be selected over other parking locations requiring the user to travel past the destination endpoint or on another route taking additional time. The parking location may also be selected because it is along a one way street that does not require the user to circle around a block or travel further to arrive at the parking location when traveling to the destination endpoint.

Thus, the parking location may be determined to minimize an amount of time reaching the destination endpoint and/or an amount of travel. In this regard, the service provider may use mapping information, which may include a plurality of maps, for example, at least one map of a location for the destination endpoint. The mapping information may be used to instruct the service provider on the closest (e.g., walking, driving, straight line, etc.), most efficient (e.g., shortest driving amount), or least far parking location from a travel route to the destination endpoint for use when traveling to the destination endpoint. The map for the destination endpoint may therefore be used to determine street usage, traffic signs, and other directions around the destination endpoint for determination of a most ideal parking location nearby the destination endpoint. The mapping information may also be used to determine traffic information, including any traffic congestions, which may be used to determine a closest, fastest, or otherwise most ideal or convenient parking location for the user at or nearby the destination endpoint.

In addition to the mapping information, the service provider may access past parking information for the user when utilizing the information. The past parking information may include one or more parking locations used by the user, which may be specific to the vehicle or generally used by the user. For example, the past parking information may include previous parking garages, lots, and other facilities used by the user. The past parking information may include information on type of parking location, such as metered, hourly, flat rate, inside, covered, outside, valet, security type (e.g., patrolled, cameras, etc.), single space or stacked parking, or other information about the parking locations used by the user. The parking information may also have a parking space size used by the user or available at the parking location for use in determining whether the user requires oversized parking or may have a small car capable of compact spaces. The service provider may also determine past parking locations used by the user with the vehicle at or nearby the destination endpoint. Thus, if the user has a preferred parking location, the service provider may determine if the user has previously used one or more of the parking locations and may determine a parking location that the user prefers to utilize.

In this regard, the past parking information may also be used to determine user preferences for parking locations, which may inform the service provider of preferred parking locations and/or information for preferred parking locations that the user would like at or nearby the destination endpoint. These user preferences may then be utilized to pick a parking location at or nearby the destination endpoint over another parking location. The user preferences may correspond to a cost of parking, security at the parking location, parking location size, parking location enclosure type, a walking distance to the destination endpoint, a travel service between the parking location and the destination endpoint, or other preference related to use of the parking location by the user. If the user chooses one parking location with certain parameters but never or rarely uses a parking location with other parameters, the service provider may determine that the user dislikes those other parameters. Similarly, if the user favors other parking location parameters, the service provider may determine the user has preferences for those parameters. The user preferences may also be determined from other user information, including personal information (e.g., age, disabilities that may affect mobility, etc.), travel information with other users, financial information, and/or other available information for the user. The user preferences may also be directly set by the user, for example, through an application of the user's computing device and stored with the service provider.

The parking location may also be determined based on user information for the user available with the device or from another online service provider. For example, the user may utilize an email, messaging, or other communication application and/or service. Emails, messages, text messages, or other data transmitted and/or received by the user may be used to determine a travel route for the user and/or a schedule for the user for arrival at the destination endpoint and/or use of the destination endpoint. In other embodiments, the application and/or online service may correspond to a scheduling service, such as a calendar application and/or service. The service provider may select a less preferred parking location, such as a more expensive parking location if the user is required to meet a schedule. In other embodiments, the service provider may otherwise optimize other user preferences based on the user's schedule and/or time required to be at the destination endpoint. Moreover, if certain parking locations only provide service for certain hours or lengths of time, these parking locations may be omitted from selection if the user is required to be at the destination endpoint for a longer amount of time than the parking location services.

If the user has various security preferences for a parking location, the service provider may access crime information for the parking locations nearby the destination endpoint and/or the location for the destination endpoint. The crime information may be available from one or more online resources, including crime prevention authorities. The crime information may be used to determine whether the parking location meets the security requirements of the user, such as no break-ins to vehicles within the last month, no assaults on patrons of the parking location, or other security requirement. The crime history may also be used to determine a security rating of the parking location, such as a number or other quantifier. For example, if the user requires parking locations to have five stars for security, the crime information may be used to determine whether one or more of the nearby parking locations to the destination endpoint meet that requirement. Additionally or instead of the crime information, the service provider may also access user reviews of the parking location, which may include reviews of cost, access, maintenance, assistance, and/or safety of the parking location, and/or a general review of the parking location. The service provider may further use the user reviews to determine the parking location selected by the user. However, if the service provider determines that there is a high enough incidences of crime and/or low enough user reviews for the parking location, the service provider may eliminate the parking location without a requirement for a user preference or setting related to security and/or user reviews.

In various embodiments, the user may decline the first provided parking location by the service provider. For example, the user may not like the travel route to the first parking location, the price, or other parameter(s) of the parking location. The service provider may then determine a second parking location, and may provide the second parking location on request by the user. The second parking location may be further determined based on a new geo-location of the user, for example, if the user take a detour or another route to the destination endpoint and would like a different parking location. Thus, the change and/or update to the parking location may be based on changes in movement of the user in the vehicle. In various embodiments, the changes may occur automatically, for example, on detection of a current location for the user and/or if the user deviates from the travel route to the parking location. In further embodiments, the service provider may provide a listing of parking locations, which may be organized according to a most highly recommended for selection by the user. Moreover, additional factors may be used to determine recommended parking locations and/or select a parking location. For example, weather may be used to select a parking location, for example, covered parking where it is rainy or hot. Air-conditioned and enclosed parking may be selected in heat or humidity. Where snow is likely, access and/or snow clearing services may further affect parking. A time of day may also be used to select a parking location, for example, if the user is utilizing the parking location late at night.

The computing device may include a payment application as one of the device applications, which may be configured to send and receive payments to another party, such as another user and/or a merchant (e.g., an entity or attendant controlling the parking location). The payment application may be associated with a payment provider, such as PayPal® or other online payment provider service, which may provide payments and other financial services on behalf of user. The payment application may execute on the computing device for the user, and may provide various functionalities and processes to the user. For example, a user may utilize the payment application to send and/or receive payments between the user and another user/merchant. The user may wish to provide a payment for a transaction with a user/merchant, transfer money to another family/friend, engage in transaction and statement review (e.g., financial dispute resolution services), or perform another financial transaction. The online payment provider may provide such services through the payment application and data sent and received over a network connection between the online payment provider and a device executing the payment application. Additionally, the online payment provider may provide payment accounts and digital wallet services, which may offer financial accounts to send, store, and receive money, process financial instruments, and/or provide transaction histories. The online payment provider may offer further services, such as extension of credit, credit history review, and other financial and personal services.

The payment application may therefore provide one or more processes and features for use of the services provided by the online payment provider. The user of the computing device may cause the device to execute the payment application to present application information to the user, such as a payment account balance or other status, pending and processed payments, receipts, transfer statuses, dispute, account information, and/or other application information. The user may further use the payment application to provide payments for parking location services, such as purchase of a parking ticket and/or parking spot, reservation of parking services, and/or valet services associated with the parking location. In this regard, the payment application may interface with the mapping application to provide payment for parking location services viewed through the mapping application. For example, the service provider and/or an entity controlling a parking location communicated to the user with a travel route to the parking location may provide an advertisement for the parking location, which may include a payment option to purchase parking at the parking location. The payment option may further include or provide a reservation option for parking at the parking location. The reservation option may function as prepayment for the parking location so payment is already completed prior to arrival at the parking location. Moreover, the reservation option may reserve a parking spot at the parking location to make sure that the user may park at the parking location when the user arrives at the parking location. The reservation may be general for any spot, or the user may specify a particular parking spot (which may have additional costs associated with the specific parking spot).

The parking location may further provider valet services to and from the parking location, which may include to and/or from the destination endpoint of the user. The service provider may select parking locations for the destination endpoint that provide valet services to either drive the user to and from the destination endpoint or pick up the user's vehicle at the destination endpoint for parking at the parking location and/or drive the user's vehicle back to the destination endpoint when the user is leaving the destination endpoint. The valet services may be advertised to the user through the mapping application and may include a selectable parking location to receive a travel route either to the parking location (e.g., where a service at the parking location may commute the user to the destination endpoint) or to the destination endpoint (e.g., where an employee picks up and/or drops off the user's vehicle at the destination endpoint). The user may also purchase and/or prepay or reserve valet services and an associated parking spot at the parking location providing the valet services through the mapping application and payment application.

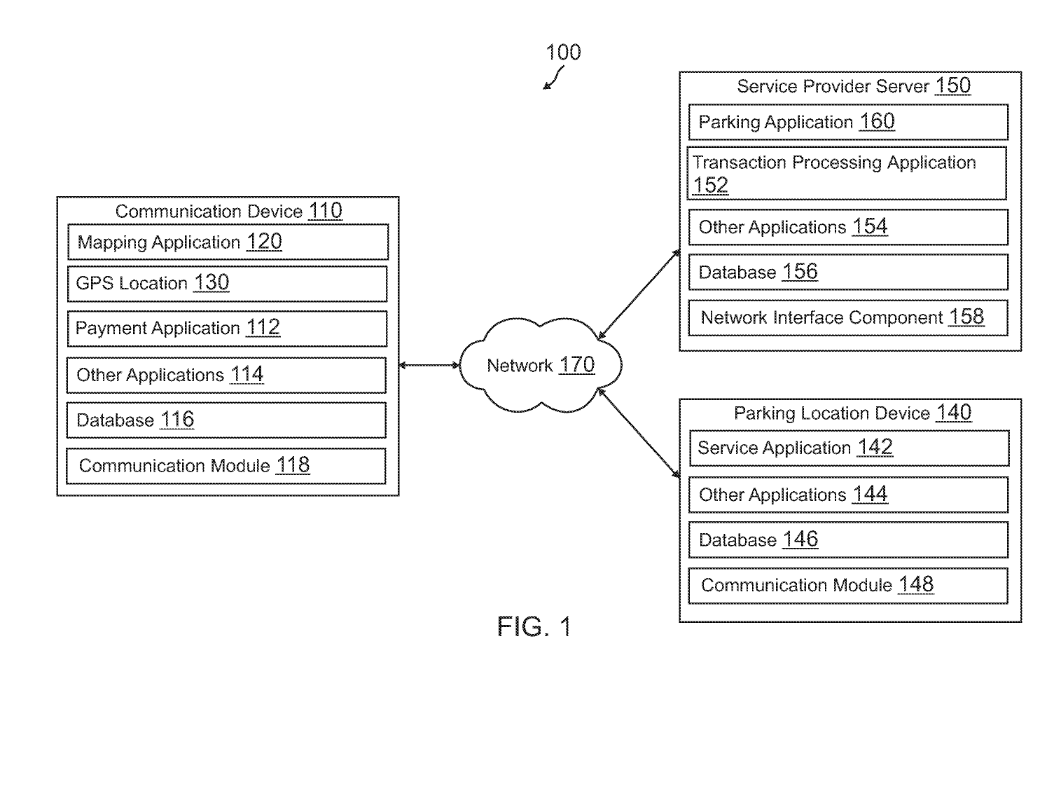

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user travelling in a vehicle (not shown), a communication device 110, a parking location device 140, and a service provider server 150 in communication over a network 160. The user may utilize communication device 110 to utilize the various features available for communication device 110, which may include processes and/or applications associated with parking location determination and travel route generation to arrive at the parking location. In this regard, the user may enter at least a destination endpoint into communication device 110, which may communicate the endpoint to service provider server 150. Service provider server 150 may determine at least one parking location nearby the destination endpoint using a map of the location for the destination endpoint. Service provider server 150 may further determine the parking location using information provided by parking location device 140. Communication device 110 may receive the parking location and a travel route to the parking location from a geo-location of the user. Moreover, communication device 110 may be used to reserve and/or prepay for parking at the parking location through parking location device 140.

Communication device 110, parking location device 140, and service provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Communication device 110 may be implemented as a communication device that may utilize appropriate hardware and software configured for wired and/or wireless communication with parking location device 140, and/or service provider server 150. For example, in one embodiment, communication device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, vehicle console computing device, other device associated with a vehicle, implantable communication devices, and/or other types of computing devices capable of transmitting and/or receiving data, such as an IPAD® from APPLE®. Communication device 110 may execute a variety of applications, including payment and other mobile applications. Although only one communication device is shown, a plurality of communication devices may function similarly.

Communication device 110 of FIG. 1 contains a mapping application 120, a GPS locator 130, a payment application 112, other applications 114, a database 116, and a communication module 118. Touch interface component 120, mapping application 120, payment application 112, and other applications 114 may correspond to executable processes, procedures, and/or applications with associated hardware. In other embodiments, communication device 110 may include additional or different modules having specialized hardware and/or software as required.

Mapping application 120 may correspond to one or more processes to execute software of communication device 110 to provide travel route determination and display of one or more travel routes between two or more endpoints to a user. In this regard, mapping application 120 may correspond to specialized hardware and/or software utilized by communication device 110 to provide map features to the user, which may include receiving a parking location associated with a destination of a user where the user may park and store their vehicle and providing a travel route to the parking location, which may further display an additional travel route to the destination endpoint (e.g., from the parking location). For example, the user of communication device may enter a destination endpoint to mapping application 120, which may correspond to a desired endpoint that the user may wish to arrive at using a vehicle of the user. In various embodiments, the user may also enter a starting location. However, mapping application 120 may also determine the starting location from a current location of communication device 110, which may be determined by GPS locator 130, as discussed herein. Mapping application 120 may also receive further updates to a current location of the user through GPS locator 130. Mapping application 120 may determine a travel route from the starting/current endpoint and the destination endpoint for the user based on stored maps for locations corresponding to the starting/current endpoint and/or the destination endpoint in database 116 of communication device 110. In other embodiments, mapping application 120 may utilize an online service provider to determine the travel route between the starting/current endpoint and the destination endpoint, for example, by communicating the starting/current endpoint and the destination endpoint to the online service provider. Once the travel route is determined and/or received, mapping application 120 may output the travel route on a map displayed on an interface of communication device 110. Mapping application 120 may also receive traffic information, weather information, and/or other travel parameters from an online resource, which may affect determination of the travel route and/or be displayed with the travel route. In various embodiments, mapping application 120 may correspond to a map application executing on a personal device of the user, such as a mobile phone device, or may correspond to a map application of a vehicle device, such as a console computing device of the vehicle.

Mapping application 120 may also communicate travel information to service provider server 150 for determination of a parking location at or nearby the destination endpoint that the user of communication device 110 may utilize to park the vehicle travelled in by the user. Mapping application 120 may also communicate the starting/current endpoint of the user with the travel information to service provider server 150, as well as a travel route between the starting/current location and the destination endpoint of the user. In other embodiments, service provider server 150 may determine the travel route between the starting/current location and the destination endpoint of the user. Service provider server 150 may determine a parking location for use by the user to park the vehicle of the user at or nearby the destination endpoint, as discussed herein. Mapping application 120 may receive the parking location from service provider server 150 and display the parking location to the user on a map of a location for the destination endpoint and the parking location. In various embodiments, mapping application 120 may determine a travel route to the parking location using stored map information comprising a map for the destination endpoint, the parking location, and/or the starting/current location. However, in other embodiments, service provider server 150 may provide a travel route from the user's starting/current location to the parking location with the parking location, as discussed herein. The travel route may include direction, a graphic for display on a visual map, and/or other information used to direct a user to the parking location from the user's starting/current location, which may be displayed using an interface of mapping application 120.

Thus, mapping application 120 may be used to receive and display parking location information from service provider server 150. Mapping application 120 may also receive advertisements for one or more parking locations determined for the vehicle utilized by the user of communication device 110, and display the advertisements to the user through an interface of mapping application 120. In various embodiments, mapping application 120 may display a reservation and/or prepayment option for a parking space at the parking location. The user may utilize an interface of mapping application 120 to select and process a reservation and/or payment for a parking space. In this regard, payment application 112 may interface with mapping application 120, for example, through application programming interface (API) calls and communications between mapping application 120 and payment application 112. Mapping application 120 may receive confirmation of refusal of the reservation and/or prepayment, as well as information to access the lot, provide proof of reservation/prepayment, and direct the user to a parking space. In various embodiments, mapping application 120 may also be used to display valet information for a parking location and a destination endpoint, such as a location to meet or access the valet, as well as how to contact the valet to retrieve the user's vehicle.

GPS locator 130 may correspond to specialized hardware and software of communication device 110 used to determine a location of a user and provide the location to one or more applications of communication device 110, such as mapping application 120 and/or payment provider application 112. GPS locator 130 may further provide the location of the user to one or more associated service providers, such as service provider server 150. GPS locator 130 may determine the location of the user using a Global Positioning System, which may utilize satellites to determine a location of communication device 110 while communication device 110 is in possession of user 102. Although GPS locator 130 is described as utilizing GPS to determine a location for communication device 110, other types of position location services and/or systems may be utilized. For example, GPS locator 130 may instead be associated with triangulation of communication device 110 through connected devices and/or communication towers or relays. GPS locator 130 may also determine a location for communication device 110 through connection to nearby devices. GPS locator 130 may be used in conjunction with mapping application 120 to determine one or more travel routes to a parking location and/or destination endpoint, as described herein.

Payment application 112 may correspond to one or more processes to execute software modules and associated devices of communication device 110 to enter one or more payment instruments or other funding sources for storage in a digital wallet associated with a payment account (e.g., stored and/or serviced by service provider server 150), access the digital wallet and/or payment account for use, and provide payments to another entity, such as an entity associated with parking location device 140 for parking services. In this regard, payment application 112 may correspond to specialized hardware and/or software utilized by a user of communication device 110 that provides an interface to permit the user to enter input and other data for payment instruments, for example, through an input device (e.g., touch screen with a graphical user interface displayed by payment application 112, keypad/keyboard, mouse, etc.) and/or through a data capture device (e.g., scanner, camera, other optical device, etc.). In various embodiments, information for the payment account may also be stored to communication device 110 for use in an offline environment. The payment account accessible through payment application 112 may be used to initiate, receive, and/or process/complete transactions using services provided by service provider server 150. Once entered, the payment instruments may be communicated to service provider server 150 over network 160 by payment application 112 for establishment and/or maintenance/update of the payment account and/or entry into the digital wallet. The user of communication device 110 may also enter benefits to payment application 112. The benefits may correspond to one or more of rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons. In other embodiments, the payment account may be with a different service provider from service provider server 150, such as a payment service provider.

Payment application 112 may be implemented as a user interface enabling the user to select and provide payment. In various embodiments, payment application 112 may include a general browser application configured to retrieve, present, and communicate information over the Internet (e.g., utilize resources on the World Wide Web) or a private network. For example, payment application 112 may provide a web browser, which may send and receive information over network 160, including retrieving website information (e.g., a website for service provider server 150), presenting the website information to the user, and/or communicating information to the website, including payment information for payment through service provider server 150. However, in other embodiments, payment application 112 may include a dedicated application of service provider server 150 or other entity (e.g., a merchant), which may be configured to assist in processing purchase requests.

Payment application 112 may be utilized to select payment instrument(s) for use in providing payment for a transaction, transfer, or other financial process. As discussed herein, payment application 112 may utilize user financial information, such as a credit card, bank account, or other financial account, as a payment instrument when providing payment information. Additionally, payment application 112 may utilize a user account with payment provider, such as service provider server 150, as the payment instrument. The payment process may be a process to purchase parking, reserve a parking space, and/or provide a prepayment for parking at a parking location corresponding to parking location device 140. Additionally, payment application 112 may be used to provide payment for valet services purchased for parking location device 140. Selection of a payment instrument may occur prior to, at, or after establishment of the financial process to pay for the parking service. Service provider server 150 may then use the payment instrument during processing of payment to the entity associated with parking location device 140. Payment application 112 may be utilized to view the results of payment, for example, using transaction histories, dispute resolution processes, and other post-transaction processes.

One or more of the aforementioned features and/or processes of mapping application 120 may be included within payment application 112 or vice versa, for example, to provide their respective features within one application and/or application interface.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking applications. Other applications may include social networking applications, media viewing, and/or merchant applications. Other applications 114 may include device interfaces and other display modules that may receive input from the user and/or output information to the user. For example, other applications 114 may contain software programs, executable by a processor, including a graphical user interface (GUI) configured to provide an interface to the user. Other applications 114 may therefore use device components of communication device 110, such as output display devices capable of displaying information to users and other output devices, including speakers.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with payment application 112 and/or other applications 114, identifiers associated with hardware of communication device 110, or other appropriate identifiers, such as identifiers used for payment/user/device authentication or identification, which may be communicated as identifying communication device 110 to service provider server 150. Mapping information used by mapping application 120 may be stored to database 116. Database 116 may include location data associated with a user, such as a starting location of a travel, a current location of the user, and/or a destination endpoint for the travel. Database 116 may also store travel routes and parking location information, such as a travel route to a parking location determined by service provider server 150.

Communication device 110 includes at least one communication module 118 adapted to communicate with parking location device 140 and/or service provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Parking location device 140 may be implemented using any appropriate hardware and software configured for wired and/or wireless communication with communication device 110 and/or service provider server 150. Although described below as a device, parking location device 140 may correspond to a portable device, server, or cloud computing architecture to provide parking information and sale of parking spots at a parking location. Parking location device 140 may further be used to process payments for parking and provide advertisements, reservations/prepayments, and/or valet services. Although only one parking device is shown, a plurality of parking devices may function similarly.

Parking location device 140 of FIG. 1 contains a service application 142, other applications 154, a database 156, and a communication module 148. Service application 142 and other applications 154 may correspond to processes, procedures, and/or applications executable by a hardware processor, for example, a software program. In other embodiments, parking location device 140 may include additional or different modules having specialized hardware and/or software as required.

Service application 142 may correspond to one or more processes to execute modules and associated specialized hardware of parking location device 140 that provides an interface and/or online resource to sell parking services to one or more users and provide information on parking at a parking location associated with parking location device 140. In this regard, service application 142 may correspond to specialized hardware and/or software of parking location device 140 to provide a convenient interface to permit a parking attendant or other parking location employee to sell parking to a user. For example, service application 142 may be implemented as an application offering sales of parking services by the parking employee through selection of parking services, entry into a transaction, and processing of the transaction. In other embodiments, service application 142 may be accessed by service provider server 140 to determine parking information, such as a price for parking, advertisements for parking services, parking location information (e.g., name, address, or other identifier), and/or other information related to a parking location for associated with parking location device 140.

Thus, service application 142 may include information retrievable by service provider server 150 when determining a parking location for the user associated with communication device 110. The parking sales data and other item data may be retrievable by communication device 110 and/or service provider server 150, such as requestable through an API call, retrievable from a database, and/or scraped from an online resource. The information may be updated periodically or continuously, such as in real time as information for the item(s) for sale changes. Service application 142 may be used to establish a transaction once the user associated with communication device 110 has requested to purchase parking admission, a parking spot, parking reservation or prepayment, and/or valet services. Once a payment amount is determined for the transaction for the parking service(s) to be purchased, service application 142 may request payment from the user. Service application 142 may receive payment processing information, such as a payment and a receipt. In such embodiments, the payment request may be processed, payment provided to the merchant account, and notification of payment (or failure, for example, where there are insufficient user funds) may be sent to service application 142. The payment may be made by service provider server 150 on behalf of the user associated with communication device 110. Service application 142 may then receive the results of the transaction processing, and complete the transaction with the user, for example, by providing parking admission and proof of parking admission to communication device 110 and/or to the user on arrival at the parking location.

Parking location device 140 includes other applications 154 as may be desired in particular embodiments to provide features to parking location device 140. For example, other applications 154 may include security applications for implementing server-side security features, programmatic client applications for interfacing with appropriate application programming interfaces (APIs) over network 160, or other types of applications. Other applications 154 may also include email, texting, voice and IM applications that allow a user to send and receive emails, calls, texts, and other notifications through network 160. In various embodiments, other applications 154 may include financial applications, such as banking, online payments, money transfer, or other applications associated with service provider server 150. Other applications 154 may contain software programs, executable by a processor, including a graphical user interface (GUI) configured to provide an interface to the user.

Parking location device 140 may further include database 156 which may include, for example, identifiers such as operating system registry entries, cookies associated with service application 142 and/or other applications 154, identifiers associated with hardware of parking location device 140, or other appropriate identifiers, such as identifiers used for payment/user/device authentication or identification. Identifiers in database 156 may be used by a payment/credit provider, such as service provider server 150, to associate parking location device 140 with a particular account maintained by the payment/credit provider. Parking information for a parking location and parking services for parking location device 140 may be stored to database 156. Database 156 may further include transaction information and/or results, including transaction histories for parking services rendered by the entity associated with parking location device 140 and purchased by the user associated with communication device 110.

Parking location device 140 includes at least one communication module 148 adapted to communicate with communication device 110 and/or service provider server 150. In various embodiments, communication module 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 150 may be maintained, for example, by an online service provider, which may provide payment and financial services to a user, as well as parking location determination services for a user traveling to a destination endpoint. In this regard, service provider server 150 includes one or more processing applications which may be configured to interact with communication device 110, parking location device 140, and/or another device/server to provide transaction processing, account services, and other financial processes. In one example, service provider server 150 may be provided by PAYPAL®, Inc. of San Jose, Calif., USA. However, in other embodiments, service provider server 150 may be maintained by or include another type of service provider, which may provide connection services to a plurality of users.

Service provider server 150 of FIG. 1 includes a parking application 160, a transaction processing application 152, other applications 154, a database 156, and a network interface component 148. Parking application 160, transaction processing application 152, and other applications 154 may correspond to executable processes, procedures, and/or applications with associated hardware. In other embodiments, service provider server 150 may include additional or different modules having specialized hardware and/or software as required.

Parking application 160 may correspond to one or more processes to execute software modules and associated specialized hardware of service provider server 150 to determine a parking location nearby a received destination endpoint based on various parking information and/or user preferences and provide the location of the parking location to communication device 110 with a travel route to the parking location. In this regard, transaction processing application 152 may correspond to specialized hardware and/or software to receive and/or access travel information for the user associated with communication device 110, where the travel information includes at least a destination endpoint selected by the user to travel to using a vehicle of the user. The destination endpoint may correspond to an endpoint that the user desires to travel to in the vehicle, and may be entered to mapping application 120 of communication device 110 and transmitted to parking application 160 as the travel information. In various embodiments, the travel information may further include vehicle information, such as a type, size, brand, or other information about the vehicle of the user. The travel information may also include a starting or current location of the user for use in determining a travel route to the destination endpoint and/or to a parking location at or nearby the destination location determined by parking application 160.

Parking application 160 may determine a parking location for use by the user in parking the user's vehicle based on the destination endpoint in the travel information. Parking application 160 may access mapping information for a plurality of locations, where the mapping information comprises maps for the plurality of locations. The maps may be used to select a parking location at or nearby the destination endpoint for the user. For example, the maps may be used to determine the easiest parking location to access or utilize at or nearby the destination endpoint. The maps may include directional elements for the roads accessing the destination endpoint and parking locations at or nearby the destination endpoint. Thus, parking application 160 may minimize an amount of time to arrive at the parking location, a distance to travel to the parking location, walking from the parking location to the destination endpoint, all of the aforementioned travel information, and/or other length parameter associated with parking at or nearby the destination location.

Parking application 160 may further access past parking utilized by the user, which may include other parking locations used by the user for other destination endpoints and/or one or more parking locations used by the user for the same or similar destination endpoint selected by the user, such as type of endpoint (e.g., concert venue, sporting venue, shopping mall, grocery store, outlet mall, movie theater, etc.). Using the past parking information for the user, parking application 160 may further select the parking location for the destination endpoint. The past parking information may be used to determine a price for parking, safety features for the parking location, a type of parking (e.g., metered fee, flat, stacked parking, single spots, covered/indoor parking, outdoor parking, attendant parking, automated parking, etc.), or other information about parking that the user prefers to use. For example, if the user often selects a flat fee for $10 daily parking in an outdoor parking lot, parking application 160 may select a similar parking location at or nearby the destination endpoint for the user. Thus, past parking for the user may be used to select parking locations which may not have the closest or shortest travel distance for the user but may be preferred by the user.

User preferences for parking may therefore be used by parking application 160 to determine a parking location for use by the user when travelling to the destination endpoint selected by the user. Parking application 160 may determine the user preferences based on past parking information, as well as additional information accessible by the user. For example, vehicle information for the user may be used to determine parking space restrictions, indoor/outdoor parking, or other user preferences for parking. Additionally, user information, such as financial information for the user, medical or other physical information for the user, personal user information, and other relevant information may be used to determine user preferences, such as walking distance, parking pricing, etc. In certain embodiments, the user may set the user preference with parking application 120, such as prices, security features, travel distances, or other configurable user preference.

In various embodiments, the user preferences may correspond to a crime rating and/or user review rating for the parking location. For example, the user may request that parking application 160 only select parking locations with a high security or safety ratings. Parking application 160 may access crime histories and ratings for the parking location and/or around the parking location. The crime histories and ratings may be retrieved from one or more authority entities and/or from reviews of the parking location by other users. The user reviews may further include review of the parking services and of facilities of the parking location. Thus, the user may specify a level or ranking required for the parking location utilize by the user. Thus, parking application 160 may be restricted to selecting only parking locations that meet or exceed a crime safety rating and/or user review rating level set by the user.

In various embodiments, the user may decline the first parking spot and request that parking application 160 determine another parking location. Parking application 160 may determine another parking location using the aforementioned information. The next parking location may be determined to be the next best parking location based on the mapping information and/or user preferences for the user. Additionally, if the user declines a parking location, parking application 130 may further adjust the user preferences based on the parking location the user does not wish to use to avoid the same or similar parking locations.

Parking application 160 may further retrieve advertisements for a selected parking location corresponding to parking location device 140. The advertisement may be communicated to communication device 110 with the parking location and/or the travel route to the parking location associated with the destination endpoint. In other embodiments, parking application 160 may generate the advertisements for use with the parking location. The advertisements may advertise one or more parking services, such as parking prices for parking spots within the parking location, prepayment for parking spots, reservation of specific parking spots, and/or valet services to and from another location.

The advertisements communicated to communication device 110 by parking application 160 may be reviewed by the user associated with communication device 110. If the user chooses to purchase one or more of the parking services offered in the advertisement, parking application 160 may be used to purchase the parking service requested by the user. Where the user wishes to prepay for parking or reserves a parking spot, parking application 160 may utilize transaction processing application 152 to process a payment, and may provide proof or prepayment/reservation to communication device 110. In other embodiments, where the user may request valet services, parking application 160 may arrange the valet services, for example, by providing a location to communication device 110 and/or parking location device 140 for the valet to pick up and/or drop off the vehicle of the user.

Transaction processing application 152 may correspond to one or more processes to execute software modules and associated specialized hardware of service provider server 150 to provide payment services to merchants and users, for example though a payment account and/or payment instruments. In this regard, transaction processing application 152 may correspond to specialized hardware and/or software to provide payment services and payment accounts, including digital wallets storing payment instruments. The payment services may allow for a payment to a parking service entity by a user through a payment instrument, including a credit/debit card, banking account, payment account with service provider server 150, and/or other financial instrument. In order to establish a payment account for a user to send and receive payments, transaction processing application 152 may receive information requesting establishment of the payment account. The information may include user personal and/or financial information. Additionally the information may include a login, account name, password, PIN, or other account creation information. The user may provide a name, address, social security number, or other personal information necessary to establish the account and/or effectuate payments through the account. Transaction processing application 152 may further allow the user to service and maintain the payment account, for example, by adding and removing payment instruments.

Transaction processing application 152 may be used to provide a payment for a parking service purchased by the user associated with communication device 110, for example, between communication device 110 and parking location device 140. Parking application 160 may arrange purchase of the parking service, which may utilize transaction processing application 152 to effectuate the purchase to parking location device 140. Transaction processing application 152 may debit an account of the user automatically and provide the payment to an account of the entity associated with parking location device 140. Transaction processing application 152 may also be used to provide transaction histories for processed transactions. Based on the transaction processing, transaction data may be pushed to communication device 110/parking location device 140 and/or pulled by communication device 110/parking location device 140.

In various embodiments, service provider server 150 includes other applications 154 as may be desired in particular embodiments to provide features to payment provider server 134. For example, other applications 154 may include security applications for implementing server-side security features, programmatic client applications for interfacing with appropriate application programming interfaces (APIs) over network 160, or other types of applications. Other applications 154 may contain software programs, executable by a processor, including a graphical user interface (GUI), configured to provide an interface to the user when accessing service provider server 150, where the user or other users may interact with the GUI to more easily view and communicate information. In various embodiments, other applications 154 may include connection and/or communication applications, which may be utilized to communicate information to over network 160.

Additionally, service provider server 150 includes database 156. As previously discussed, the user and/or the merchant corresponding to telecommunication carrier server 170 may establish one or more digital wallets and/or payment accounts with service provider server 150. Digital wallets and/or payment accounts in database 156 may include user information, such as name, address, birthdate, payment instruments/funding sources, additional user financial information, user preferences, and/or other desired user data. Users may link to their respective digital wallets and/or payment accounts through an account, user, merchant, and/or device identifier. Thus, when an identifier is transmitted to service provider server 150, e.g., from communication device 110, one or more digital wallets and/or payment accounts belonging to the users may be found. Database 156 may also store travel information for a user, as well as mapping information for a plurality of locations and user preferences for the user.

In various embodiments, service provider server 150 includes at least one network interface component 148 adapted to communicate communication device 110 and/or parking location device 140 over network 160. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

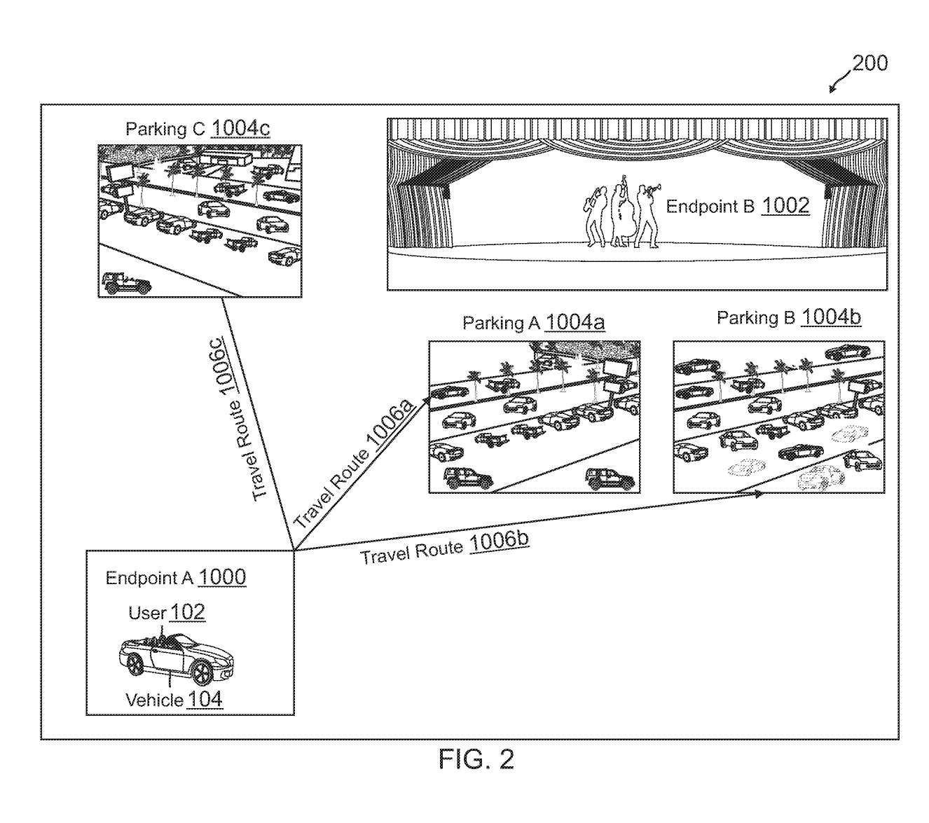

FIG. 2 is an exemplary environment having travel routes to parking locations determined based on mapping information and a destination endpoint. Environment 200 includes a user 102 utilizing a vehicle 104. In this regard, user 102 may utilize a communication device to arrange travel to a destination endpoint, where the communication device may correspond to communication device 110 in environment 100 of FIG. 1. Moreover, the communication device may communicate with one or more devices, servers, or cloud computing architectures corresponding generally to parking location device 140 and/or service provider server 150 in environment 100 of FIG. 1.

User 102 may be located at a location A 1000 in vehicle 104. Location A 1000 may correspond to a starting and/or current location of user 102 in vehicle 104. Location A 1000 may be detected using a location detection service of the communication device in possession of user 102 in vehicle 104. In this regard, location A 1000 may include GPS coordinates to identify the location of the user.

User 102 may enter a destination endpoint that the user wants to travel to in vehicle 104, for example, through the communication device in possession of the user. The destination location may correspond to endpoint B 1002, where user 102 wishes to travel from location A 1000 to endpoint B 1002 using vehicle 104. However, as shown in environment 200, endpoint B 1002 does not have a parking location at endpoint B 1002 and instead has three parking locations, a parking A 1004a, a parking B 1004b, and a parking C 1004c nearby endpoint B 1002. Each of parking A 1004a, parking B 1004b, and parking C 1004c may each have different parking properties, such as an ease of access by user 102 in vehicle 104, a length of travel to access from location A 1000, and parking location information (e.g., price, security, parking type, and other previously discuss parameter associated with parking at the parking location.

Thus, a service provider may receive travel information indicating that user 102 wishes to travel from location A 1000 to endpoint B 1002 in vehicle 104. The service provider may access mapping information at and around endpoint B 1002, which may include maps for location A 1000 as well as any locations between location A 1000 and endpoint B 1002. In this regard, the service provider may view the map information and determine that a shortest travel route to a parking location for endpoint B 1002 may correspond to a travel route 1006a to parking A 1004a. Thus, as shown in environment 200, user 102 may utilize travel route 1006a in vehicle 104 to travel to parking A 1004a and utilize parking A 1004a while traveling to endpoint B 1002.

However, in other embodiments, the user may have a user preference to park at a cheaper parking lot, which may take longer to arrive at. For example, parking B 1004b may offer cheaper parking rates than parking A 1004a. However, as shown in environment 200, a travel route 1006c is longer than travel route 1006a, and thus, will take longer to arrive at parking B 1004b from location A 1000 than parking A 1004a from location A 1000. In this regard, parking B 1004b may be chosen based on price considerations by the service provider, and travel route 1006b may be provided to user 102 on the communication device of user 102. Moreover, parking B 1004b may also be chosen based on scheduling consideration of user 102, for example, if user 102 has additional time to arrive at endpoint B 1002 and would like cheaper parking rates.

In other embodiments, the user preferences may select the safest parking location or the parking location with the highest overall user review rating. For example, parking C 1004c may be located the furthest from endpoint B 1002 but have the best crime rating and/or user reviews. Thus, if user 102 expresses preferences for the highest crime ratings and/or user reviews, then parking C 1004c may be selected as the parking location for endpoint B 1002. Additionally, the service provider may communicate travel route 1006c to the communication device of user 102.

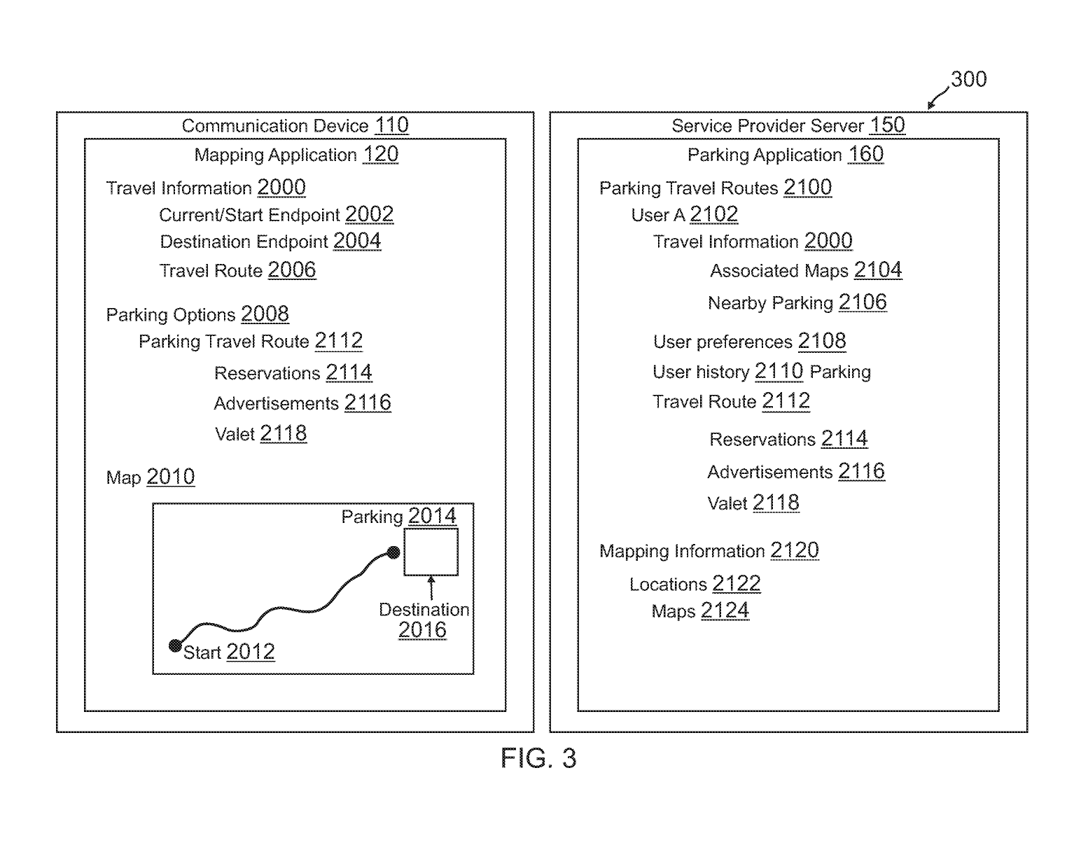

FIG. 3 is an exemplary system environment showing a communication device of a user receiving a travel route to a parking location determined from mapping information around a destination endpoint for the user, according to an embodiment. FIG. 3 includes communication device 110 and a service provider server 150 as discussed in reference to environment 100 of FIG. 1.

Communication device 110 executes mapping application 120 corresponding generally to the specialized hardware and/or software modules and processes described in reference to FIG. 1. In this regard, mapping application 120 may include information used to determine a parking location for a destination endpoint of the user associated with communication device 110. For example, mapping application 120 includes travel information 2000 entered by the user for a location the user is travelling to. Travel information 2000 includes a current/start location 2002 and a destination endpoint 2004. Additionally, travel information 2000 may include a travel route 2006 between current/start location 2002 and destination endpoint 2004. Travel information 2000 may be communicated to service provider server 150 for determination of a parking location at or nearby destination endpoint 2004 for use by the user.

Thus, service provider server 150 executes parking application 160 corresponding generally to the specialized hardware and/or software modules and processes described in reference to FIG. 1. In this regard, parking application 160 may be used to determine the aforementioned parking location at or nearby destination endpoint 2004 in travel information 2000 for mapping application 120. Thus, parking application 160 includes parking travel routes 2100, which may include parking location and travel routes determined for a user A 2012. For example, user A 2012 may be associated with travel information 2000 from mapping application 120. Parking application 160 may further access associated maps 2104 for travel information 2000 and may determine nearby parking 2106 for the destination endpoint 2004, which may include one or more parking locations usable by the user of communication device 110.

Parking application 160 may further access user preferences 2108 for user A 2102, which may include various parking preferences for user A 2102 for parking locations that the user wishes to utilize. Parking application 160 may determine user preferences at least in part using a user history 2110 for user A 2102, which may include past parking locations utilized by the user. Using the aforementioned information, parking application 160 may determine parking travel route 2112 to a selected parking locations. Parking travel route 2112 may further include various parking services used for the parking location correspond to parking travel route 2112, such as reservations 2114, advertisements 2116, and/or valet 2118. Moreover, parking application 160 may be associated with mapping information 2120 for determination of parking travel routes 2112, which may include locations 2122 having maps 2124.

Thus, parking application 160 may communicate information for parking travel route 2112 selected by parking application 160 to communication device 110 for display to the user of communication device 110 through mapping application 120. Mapping application 120 may include parking options 2008 for use with travel information 2000. For example, parking options 2008 includes parking travel route 2112 selected by parking application 160, as well as the parking services for the parking location for parking travel route 2112, including reservations 2114, advertisements 2116, and/or valet 2118. Mapping application 120 may further include a map 2010, which may display a start location 2012, a destination location 2016, and a travel route to a parking location 2014.

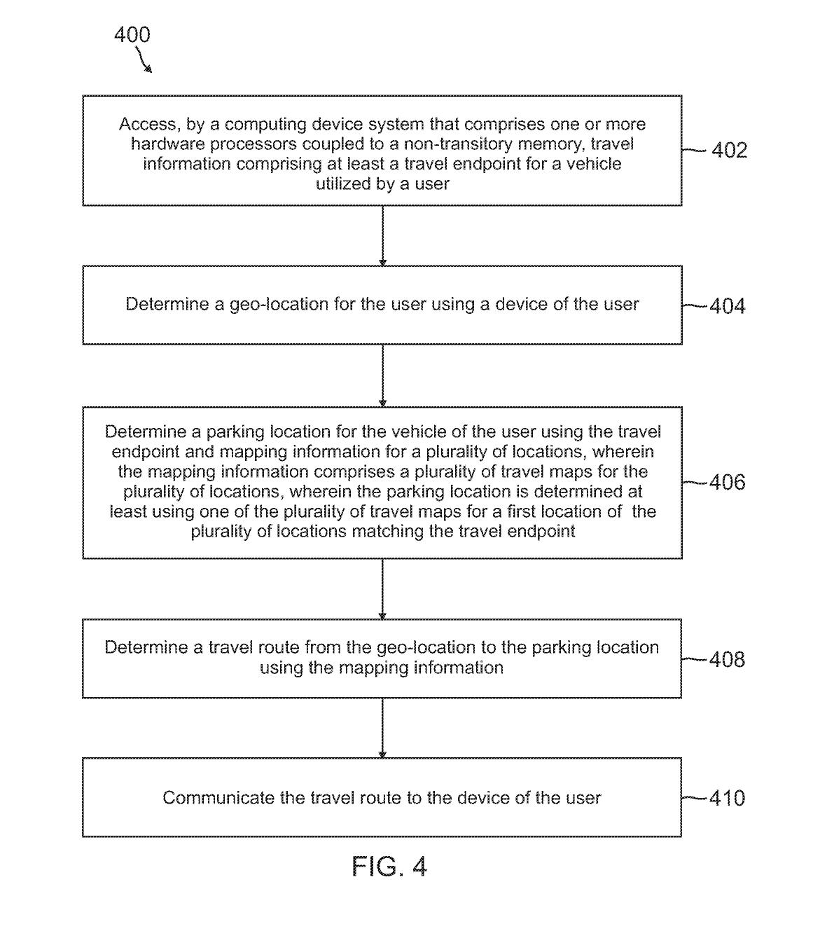

FIG. 4 is a flowchart of an exemplary process for location detection and user information processing for intelligent selection of parking locations, according to an embodiment. Note that one or more steps, processes, and methods described herein may be omitted, performed in a different sequence, or combined as desired or appropriate.

At step 402, travel information comprising at least a travel endpoint for a vehicle utilized by a user is accessed, for example, by a computing device system that comprises one or more hardware processors coupled to a non-transitory memory. The travel information may further comprise vehicle information for the vehicle utilized by the user, and wherein the vehicle information comprises a type for the vehicle and a transportation mode for the vehicle. A geo-location for the user is determined, at step 404, using a device of the user. In various embodiments, the device may comprise one of a mobile communication device of the user and a GPS capable device of a console computing device of the vehicle.

At step 406, a parking location for the vehicle of the user is determined using the travel endpoint and mapping information for a plurality of locations, wherein the mapping information comprises a plurality of travel maps for the plurality of locations, and wherein the parking location is determined at least using one of the plurality of travel maps for a first location of the plurality of locations matching the travel endpoint. The parking location may be further determined using the first geo-location of the user. At least one past parking location utilized by the user at or nearby the travel endpoint for the travel route may be determined, and the parking location further determined based on the at least one past parking location. Additionally, user preferences for parking locations set by the user with the service provider system may be accessed, wherein the user preferences comprise at least one of security at the parking locations, a price for parking at the parking locations, and a distance from the parking locations to a destination location. Such user preferences may be used to determine the parking location. Additionally, user reviews of parking locations at or nearby the travel endpoint and/or crime reports at or nearby the travel endpoint may be accessed and used to determine the parking location. In further embodiments, user scheduling information, such as upcoming reservations, appointments, ticketed events, or other scheduled items may be accessed and used to select a parking location.

In various embodiments, past parking information for the user with the vehicle is accessed, and user preferences for parking for the user is determined from the past parking information and the vehicle information for the vehicle, wherein the user preferences for parking comprise at least one of an internal or external parking preference, a paid attendant parking preference, an automated parking payment preference, a single spot or stacked parking preference, and a flat or hourly parking preference. In further embodiments, user information for the user is determined, wherein the user information is determined from at least one application executing on the device for the user. The parking location may be further determined using the aforementioned information.

A travel route from the geo-location to the parking location is determined using the mapping information, at step 408. In further embodiments, a second geo-location for the user may be determined using the device of the user, and the travel route updated using the second geo-location. The travel route may be further determined using at least one of the plurality of travel maps for a second location of the plurality of locations matching the first geo-location of the user. At step 410, the travel route is communicated to the device of the user. A request to change the parking location determined for the user for the travel endpoint may be received, wherein the request comprises at least one preference for a different parking location. The different parking location for the user may be determined using the at least one preference, and communicated to the user on the device of the user or updated on the travel route with the different parking location.

A reservation option for a parking space at the parking location may be generated and communicated to the device of the user. An advertisement for the parking space may also be generated and communicated to the user with the reservation option. In other embodiments, a prepayment option for the parking location on behalf of the user may be generated and communicated to the device of the user. Thus, a payment to an entity controlling the parking location may be processed if the user accepts the prepayment option. In various embodiments, a valet feature between the travel endpoint for the user and the parking location for the vehicle utilized by the user is determined and communicated to the device of the user. Thus, the service provider system may communicate the valet feature to a device of a valet associated with the parking location on acceptance of the valet feature by the user in order to arrange the valet service.

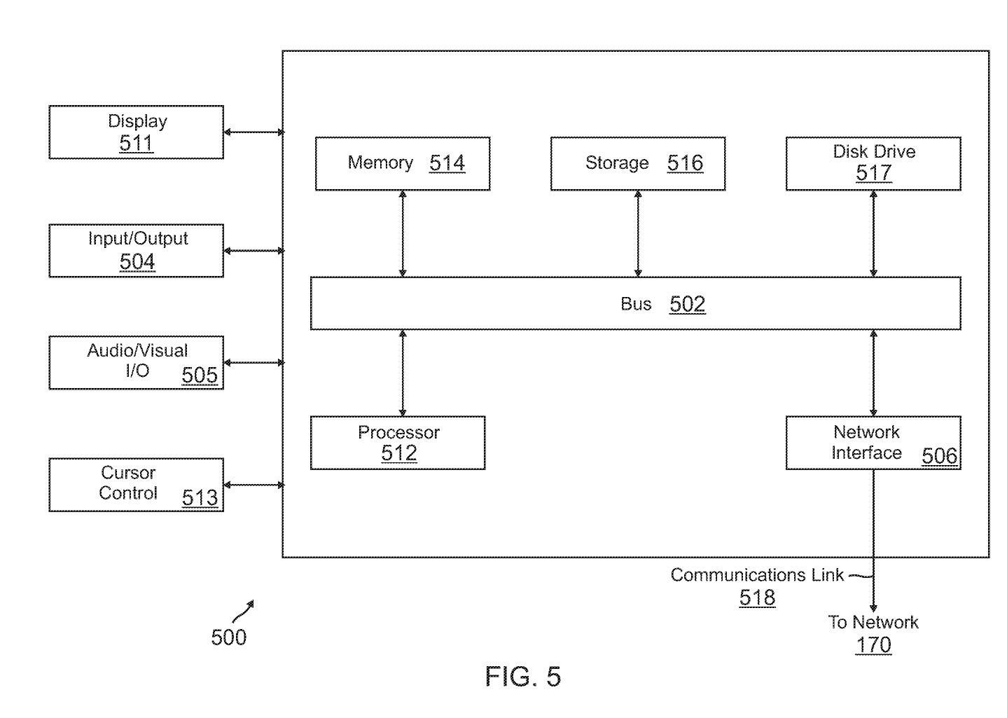

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory storing mapping information for a plurality of locations, wherein the mapping information comprises a plurality of travel maps for the plurality of locations; and
one or more hardware processors coupled to the non-transitory memory and configured to read instructions from the non-transitory memory to cause the system to perform operations comprising:
receiving travel information comprising at least a travel endpoint for a vehicle utilized by a user;
determining a first geo-location for the user using a device of the user;
determining a parking location for the vehicle of the user using the travel endpoint and the mapping information, wherein the parking location is determined at least using one of the plurality of travel maps for a first location of the plurality of locations matching the travel endpoint;
determining a travel route from the first geo-location to the parking location using the mapping information; and
communicating the travel route to the device of the user.

2. The system of claim 1, wherein the travel information further comprises vehicle information for the vehicle utilized by the user, and wherein the vehicle information comprises a type for the vehicle and a transportation mode for the vehicle.

3. The system of claim 2, wherein the device comprises one of a mobile communication device of the user and a GPS capable device of a console computing device of the vehicle.

4. The system of claim 2, wherein the one or more hardware processors are further configured to read instructions from the non-transitory memory to cause the system to perform further operations comprising:
accessing past parking information for the user with the vehicle; and
determining user preferences for parking for the user from the past parking information and the vehicle information for the vehicle, wherein the user preferences for parking comprise at least one of an internal or external parking preference, a paid attendant parking preference, an automated parking payment preference, a single spot or stacked parking preference, and a flat or hourly parking preference, wherein the determining the parking location for the vehicle further uses the user preference for parking.

5. The system of claim 1, wherein the one or more hardware processors are further configured to read instructions from the non-transitory memory to cause the system to perform further operations comprising:
determining user information for the user, wherein the user information is determined from at least one application executing on the device for the user,
wherein the travel route is further determined using the user information.

6. The system of claim 1, wherein the parking location is further determined using the first geo-location of the user.

7. The system of claim 1, wherein the one or more hardware processors are further configured to read instructions from the non-transitory memory to cause the system to perform further operations comprising:
determining at least one past parking location utilized by the user at or nearby the travel endpoint for the travel route,
wherein the parking location is further determined using the at least one past parking location.

8. The system of claim 1, wherein the one or more hardware processors are further configured to read instructions from the non-transitory memory to cause the system to perform further operations comprising:
determining a second geo-location for the user using the device of the user; and
updating the travel route to the parking location using the second geo-location for the user.

9. The system of claim 1, wherein the travel route is further determined using at least one of the plurality of travel maps for a second location of the plurality of locations matching the first geo-location of the user.

10. The system of claim 1, wherein the one or more hardware processors are further configured to read instructions from the non-transitory memory to cause the system to perform further operations comprising:
receiving a request to change the parking location determined for the user for the travel endpoint, wherein the request comprises at least one preference for a different parking location;
determining the different parking location for the user using the at least one preference; and
updating the travel route with the different parking location using the mapping information.

11. The system of claim 1, wherein the one or more hardware processors are further configured to read instructions from the non-transitory memory to cause the system to perform further operations comprising:
accessing user preferences for parking locations set by the user with the service provider system, wherein the user preference comprise at least one of security at the parking locations, a price for parking at the parking locations, and a distance from the parking locations to a destination location,
wherein the parking location is further determined using the user preferences.

12. The system of claim 1, wherein the one or more hardware processors are further configured to read instructions from the non-transitory memory to cause the system to perform further operations comprising:
accessing user reviews of parking locations at or nearby the travel endpoint,
wherein the parking location is further determined based on the user reviews of the parking locations.

13. The system of claim 1, wherein the one or more hardware processors are further configured to read instructions from the non-transitory memory to cause the system to perform further operations comprising:
accessing crime reports at or nearby the travel endpoint,
wherein the parking location is further determined based on the crime reports.

14. The system of claim 1, wherein
accessing user scheduling information for the user,
wherein the parking location is further determined based on the user scheduling information.

15. A method comprising:
accessing, by a computing device system that comprises one or more hardware processors coupled to a non-transitory memory, travel information comprising at least a travel endpoint for a vehicle utilized by a user;
determining a geo-location for the user using a device of the user;
determining a parking location for the vehicle of the user using the travel endpoint and mapping information for a plurality of locations, wherein the mapping information comprises a plurality of travel maps for the plurality of locations, and wherein the parking location is determined at least using one of the plurality of travel maps for a first location of the plurality of locations matching the travel endpoint;
determining a travel route from the geo-location to the parking location using the mapping information; and
communicating the travel route to the device of the user.

16. The method of claim 15, further comprising
generating a reservation option for a parking space at the parking location; and
communicating the reservation option to the device of the user.

17. The method of claim 16, further comprising:
generating an advertisement for the parking space at the parking location,
wherein the advertisement is communicated to the device of the user with the reservation option.

18. The method of claim 15, further comprising:
generating a prepayment option for the parking location on behalf of the user;
communicating the prepayment option to the device of the user; and
processing a payment to an entity controlling the parking location if the user accepts the prepayment option.

19. The method of claim 15, further comprising:
determining a valet feature between the travel endpoint for the user and the parking location for the vehicle utilized by the user;
communicating the valet feature to the device of the user; and
communicating the valet feature to a device of a valet associated with the parking location on acceptance of the valet feature by the user.

20. A non-transitory machine-readable medium having stored thereon machine-readable instructions executable to cause a machine to perform operations comprising:
accessing, by a computing device system that comprises one or more hardware processors coupled to a non-transitory memory, travel information comprising at least a travel endpoint for a vehicle utilized by a user;
determining a geo-location for the user using a device of the user;
determining a parking location for the vehicle of the user using the travel endpoint and mapping information for a plurality of locations, wherein the mapping information comprises a plurality of travel maps for the plurality of locations, and wherein the parking location is determined at least using one of the plurality of travel maps for a first location of the plurality of locations matching the travel endpoint;
determining a travel route from the geo-location to the parking location using the mapping information; and
communicating the travel route to the device of the user.
